(19) United States
(12) Patent Application Publication
(10) Pub. No.: US 2002/0110445 A1
(43) Pub. Date: Aug. 15, 2002

(54) Apparatus and method for transporting with an automotive vehicle a straddled sports vehicle

(76) Inventor: Jon Odegaard, Whittier, CA (US)

Correspondence Address: ROBERT J. SCHAAP, Suite 188, 21241 Ventura Boulevard, Woodland Hills, CA, 91364, US

(21) Appl. No.: 10/071,823

(22) Filed: Feb. 8, 2002

Related U.S. Application Data
(60) Provisional application No. 60/268,216, filed on Feb. 9, 2001.

(51) Int. Cl. B60P 3/07

(52) U.S. Cl. 414/563

(57) ABSTRACT

A lift and support apparatus for lifting a motorcycle or similar sports vehicle of the type which is straddled in use from a ground surface and automatically holding the straddled type sports vehicle on the rear of an automotive vehicle. The apparatus uses a frame work secured to the automotive vehicle and includes a support rail capable of raising and lowering a carriage support at its outer end. The carriage support is provided with locking members for releasably locking the motorcycle or other straddled type sports vehicle onto the carriage support. When raised, the carriage support will hold the sports vehicle in an upright position for transport, and thereafter allow for lowering to a ground surface.

### BACKGROUND OF THE INVENTION

1. Field of the Invention

This invention relates in general to certain new and useful improvements in apparatus for loading and transporting straddled type sports vehicles, such as motorcycles and the like, at the rear of an automotive vehicle. More particularly, the invention relates to an apparatus and a method of this type which includes a carriage support which will hold such a sports vehicle of the type which is straddled, such as a motorcycle, to enable raising and lowering of same and transport of same while in a fully upright position.

2. Brief Description of Related Art

Many users of motor driven sports vehicles in the nature of motorcycles, jet skis and similar recreational or sports vehicles, are frequently desirous of transporting their sports vehicle with them, so that the latter may be used at a particular destination. As an example, a recreational vehicle user may desire to also transport to a particular destination, a motorcycle or other sports vehicle. However, in almost all cases, the motorcycle or similar vehicle must be loaded onto the bed of a flat pickup truck, or otherwise onto a trailer pulled by the automotive vehicle.

Specially designed trailers are available for loading jet skis onto a trailer and transporting same to a site of use. However, the jet skis themselves usually have considerable weight and they are not readily and easily disposed on a trailer. In the case of a motorcycle, the vehicle must be moved up a ramp and onto a bed of the trailer. This trailer is specifically designed to retain a motorcycle. However, when the motorcycle is moved onto the bed of the trailer, it must then be tied down so that it will be capable of being transported. Moreover, motorcycles, in particular, must be secured in such manner that they will not tip over during transport. Any inadvertent tipping of a motorcycle and causing the same to land on its side, could result in serious damage to the motorcycle, and potentially to the automotive vehicle, not to mention the loss of gas from the tank of the motorcycle, which could present a fire hazard.

The only presently available vehicle which can be used for transporting a sports vehicle, such as a motorcycle, is a truck, including pickup trucks, which have a flat bed. However, as indicated, it is necessary to move, usually by manual force, the motorcycle up a ramp onto the bed of the truck, and then tie the motorcycle in such manner that it is vertically stable. Usually this requires fairly taut cables extending from the motorcycle to the bed of the truck. Otherwise, the motorcycle could be tied to a panel of the truck if such is available. In either case, cables can damage the motorcycle or otherwise the jarring of the motorcycle during transport against a panel of the pickup truck can also damage the motorcycle. Consequently, the presently available means for moving motorcycles have serious limitations.

Tow trucks are effective for transporting an automotive vehicle such as a passenger automobile. In the case of a tow truck, a boom extends from the rear of the truck and has a structure extendable therefrom to reach the automotive vehicle to be towed. Moreover, the boom can be raised and lowered in order to facilitate movement of the automotive vehicle. However, in this case, there is no necessity to maintain the automotive vehicle in a true upright condition. Rather, when a front end, for example, of an automotive vehicle is engaged by the boom, it is raised relative to the back end and hence the vehicle itself is not truly vertically oriented. Moreover, this structure is not adaptable for movement of single or dual passenger sports vehicles, such as jet skis or motorcycles.

Some public buses are equipped with bicycle hauling devices on the front portion thereof, which have hooks to receive and engage the frame of a bicycle. Moreover, these hooks are openable and closable to tightly engage the bicycle. However, in this case, the bicycle must be manually loaded onto the hooks or other transport mechanism. Beyond these present commercially available means for transporting single passenger or dual passenger sports vehicles, there is essentially nothing which is effective in enabling the transport of the sports vehicle by an automotive vehicle, in absence of a trailer designed to hold and transport same.

Today, there is no convenient and easily usable mechanism which allows for transport of a single or dual passenger sports vehicle, such as a jet ski or motorcycle, with an automotive vehicle and without the need for attachment of a trailer for transporting such sports vehicle. The specially designed trailers are effective for this purpose, although they are relatively expensive, they require hitching for use and unhitching after use, they require a place for storage, and the typical attendant maintenance. The high cost for purchase of such trailers, alone, can severely militate against their use.

It would be desirable to provide an attachment to an automotive vehicle which could be used for transporting a motorcycle or similar sports vehicle with that automotive vehicle, even if the same did not include a flat bed on a portion thereof.

### OBJECTS OF THE INVENTION

It is, therefore, one of the primary objects of the present invention to provide an apparatus readily attachable to a wide variety of automotive vehicles which enables for the loading and transport of a single or dual passenger straddled type sports vehicle.

It is another object of the present invention to provide an apparatus which can be attached to a rear of an automotive vehicle for causing a lifting of a sports vehicle for transport, and extension of the sports vehicle and lowering of the sports vehicle, to a ground surface after transport thereof to a selected destination.

It is a further object of the present invention to provide an apparatus for raising a straddle type sports vehicle at the rear portion of an automotive vehicle transporting same and lowering same, and which includes a frame capable of being mounted to an underside of the automotive vehicle without extending beyond the perimeter of the automotive vehicle.

It is also an object of the present invention to provide an apparatus of the type stated for raising, lowering and transporting an auxiliary vehicle at the rear portion of an automotive vehicle, and which includes a carriage support operatively coupled to and movable with the frame mounted on the vehicle and also independently of the frame.

It is still another object of the present invention to provide an apparatus for raising, lowering and transporting a sports vehicle, and which can be manufactured at a relatively low cost, is highly efficient in operation, and does not impair the operation of the automotive vehicle.

It is another salient object of the present invention to provide a method for loading and transporting a motor driven straddle type sports vehicle on an automotive vehicle allowing for easy loading of the sports vehicle onto a carriage, raising the carriage, and moving the carriage to a position of adjacent relationship to the rear of the automotive vehicle for transport thereof and then lowering the sports vehicle to a ground surface.

It is still a further object of the present invention to provide a method for loading and transporting a motor driven straddle type sports vehicle onto a carriage support at the rear portion of an automotive vehicle, and which allows for easy loading by a single operator and eliminates the time consuming necessity of securing the sports vehicle to a carriage support.

With the above and other objects in view, my invention resides in the novel features of form, construction, arrangement and combination of parts presently described and pointed out in the claims.

### BRIEF SUMMARY OF THE INVENTION

The present invention relates primarily to an apparatus which can be secured to an automotive vehicle and particularly on the underside of an automotive vehicle for raising and lowering a straddled type sports vehicle or similar auxiliary vehicle, and transporting same to a destination and lowering the sports vehicle again to a ground surface. In particular, the term “straddled” sports vehicle or “straddled type” sports vehicle, will relate primarily to those motor driven vehicles which have two running members, as for example, two wheeled motorcycles. However, it should be understood that the invention is not so limited and is capable of raising, lowering and transporting other types of vehicles as well.

The automotive vehicle can be essentially any form of vehicle in which the frame of the apparatus of the invention can be mounted on the undercarriage thereof, adjacent to the rear portion of a vehicle. Exemplary of such vehicles include vans and mini-vans, pickup trucks, recreational vehicles, flatbed trucks, passenger sedans and a variety of other automotive vehicles. The apparatus is designed so that it can be mounted to the chassis forming part of the automotive vehicle.

One of the important aspects of the present invention is that the apparatus of the invention is designed to hold the straddled type sports vehicle in a generally upright position, both during the loading and unloading process, as well as during transport. Otherwise, damage to the sports vehicle or even to the automotive vehicle can result, not to even mention the potential for hazard from leaking gas tanks and possible resultant fire if the sports vehicle should tip over.

The apparatus of the present invention includes a plurality of individual drives which allow for individual movements of a carriage support adapted to engage the underside of the sports vehicle. The apparatus includes a frame mounted on the underside of the automotive vehicle, and which includes a boom extendable from the frame in a telescoping arrangement. Mounted at the outer end of the boom is the carriage support. Moreover, the carriage support is provided with means for engaging and holding the sports vehicle on the carriage support, so that the sports vehicle can be raised from a ground surface to an elevated position adjacent to the automotive vehicle.

More specifically, a first drive means is provided for raising and lowering the boom so that the carriage support may be moved from an elevated position down to a ground surface to enable loading of the sports vehicle onto the carriage support and raising same back up to an elevated position spaced above the ground surface. A second drive means is provided for extending and retracting the boom so that the carriage support may be placed at a position spaced from the automotive vehicle. This drive means also causes retracting movement to bring the sports vehicle back into adjacent relationship to the rear portion of the automotive vehicle.

The second drive means may be so constructed, or a third drive means may be provided for tilting the carriage support simultaneously with movement of the boom in a vertical path. In this way, the drive means effectively operates in coordination with the movement of the boom to enable the carriage support to remain in a position where the sports vehicle carried thereon is always held upright.

The carriage support is provided with an additional drive means which allows for a mounting means on the carriage support to engage the straddled type sports vehicle. More particularly, these mounting means may adopt the form of pivotal hooks which are operable by this additional or fourth drive means to physically engage and hook a portion of the frame of the sports type vehicle, or a member added to the sports type vehicle, to thereby securely hold the sports vehicle on the carriage support. Moreover, these hook means and the shape of the carriage support is arranged so that the sports vehicle carried thereon will remain in the upright position during transport.

The drive means of the invention may be electrically operated drive means or they may be pure hydraulic drive means. The exact type of drive means, however, is not critical in accordance with the present invention. Typically, the drive means are in the nature of drive cylinders.

Also in a preferred embodiment, a pair of drive means are used in combination to cause pivoting movement of the support carriage for holding the sports vehicle in the upright position, to thereby maintain a type of rectangular or parallelogram structure from the frame to the carriage support.

The drive means which raises and lowers the boom may be in the form of a drive motor rotating pulleys or cable sprockets upon which cables or chains can be trained and engage the boom. In this way, the boom can be raised and lowered.

The drive means which operate the mounting means is primarily a piston cylinder drive means, as aforesaid, and is pivotally mounted on the carriage. In this way, the drive means can pivot so as to enable a pivoting movement of the links. Moreover, the links are repositionable on the carriage support so as to enable hooking to a variety of vehicles of differing construction. In this way, if a main frame member of a sports vehicle is in a different position than another sports vehicle, the hooks can be moved in order to accommodate each of the types of sports vehicles.

The present invention can therefore be described in broad terms as an apparatus for loading and transporting at the rear of an automotive vehicle, a motor driven sports vehicle of a type supported on two running members. This apparatus comprises a frame capable of being mounted on the underside of the automotive vehicle, and a main beam extendable outwardly from the frame. A carriage support is mounted on the outer end of the main beam and adapted to engage an undercarriage of the motor driven sports vehicle. Means is associated with said carriage support in order to hold the sports vehicle in a generally upright position and in addition, means is provided for lowering the main beam and raising same so that when the motor driven sports vehicle is secured to the carriage support, it will be retained thereon for transport in a generally upright position without further tying or securement.

The invention can also be described in broad terms as an apparatus for raising and lowering and transporting an auxiliary vehicle at the rear portion of an automotive vehicle. This apparatus includes a frame means mounted on the rear portion of the automotive vehicle, and a carriage support coupled to and movable with the frame and also independently of the frame. In addition a mounting means is located on the carriage support for releasably mounting the auxiliary vehicle thereon.

In accordance with the above construction, the auxiliary vehicle can be completely lifted from the ground surface to a raised transport position. There is also provided means for raising and lowering the carriage support so that the auxiliary vehicle is completely lifted from a ground surface, and where the auxiliary vehicle is automatically retained in a generally upright position during raising and lowering movement and during transport.

Finally, the invention can also be described in broad terms as a method for loading and transporting a motor driven straddle type sports vehicle onto an apparatus which carries same with an automotive vehicle, and which allows for transport with the automotive vehicle. In this case, the method comprises lowering the carriage support to a ground surface for receiving the motor driven sports vehicle and moving the sports vehicle onto the carriage support. Thereafter, the method provides for releasably mounting the sports vehicle on the carriage support. The carriage support is raised to a raised position above a ground surface and simultaneously holding the sports vehicle in that position, so that the motor driven sports vehicle can be always held in an upright position. The motor driven sports vehicle is then transported to a destination where the carriage support is lowered to a ground surface and the motor driven sports vehicle removed from the carriage support.

This invention possesses many other advantages and has other purposes which may be made more clearly apparent from a consideration of the forms in which it may be embodied. These forms are shown in the drawings forming a part of and accompanying the present specification. They will now be described in detail for purposes of illustrating the general principles of the invention. However, it is to be understood that the following detailed description and the accompanying drawings are not to be taken in a limiting sense.

### BRIEF DESCRIPTION OF THE DRAWINGS

Having thus described my invention in general terms, reference will now be made to the accompanying drawings in which:

FIG. 1 is a side elevational view of an automotive vehicle in the nature of a pickup truck having the apparatus of the present invention mounted thereon, and showing a motorcycle raised to an elevated and transport position;

FIG. 2 is a fragmentary side elevational view, similar to FIG. 1, but showing a carriage support forming part of the apparatus of the invention lowered to a ground surface to enable loading or unloading of a motorcycle thereon;

FIG. 3 is a perspective view of the apparatus for loading and transporting a sports vehicle, and with the carriage support thereof in an elevated position for transport;

FIG. 4 is a perspective view, similar to FIG. 3, and showing the carriage support of the apparatus in a lowered position to a ground surface for loading and unloading of a sports vehicle thereon;

FIG. 5 is a top plan view of the apparatus of the present invention;

FIG. 6 is a fragmentary perspective view, partially broken away, and showing a drive mechanism and a mounting means on the carriage support of the invention for releasably holding a sports vehicle on the carriage support;

FIG. 7 is a somewhat schematic perspective view showing a pair of drive members for maintaining the carriage support in a position where a sports vehicle held thereon is always in an upright position; and

FIG. 8 is a composite view of the two rail portions of the carriage support and showing the alternate positioning of the hook members forming part of the locking means of the present invention.

### DETAILED DESCRIPTION OF A PREFERRED EMBODIMENT

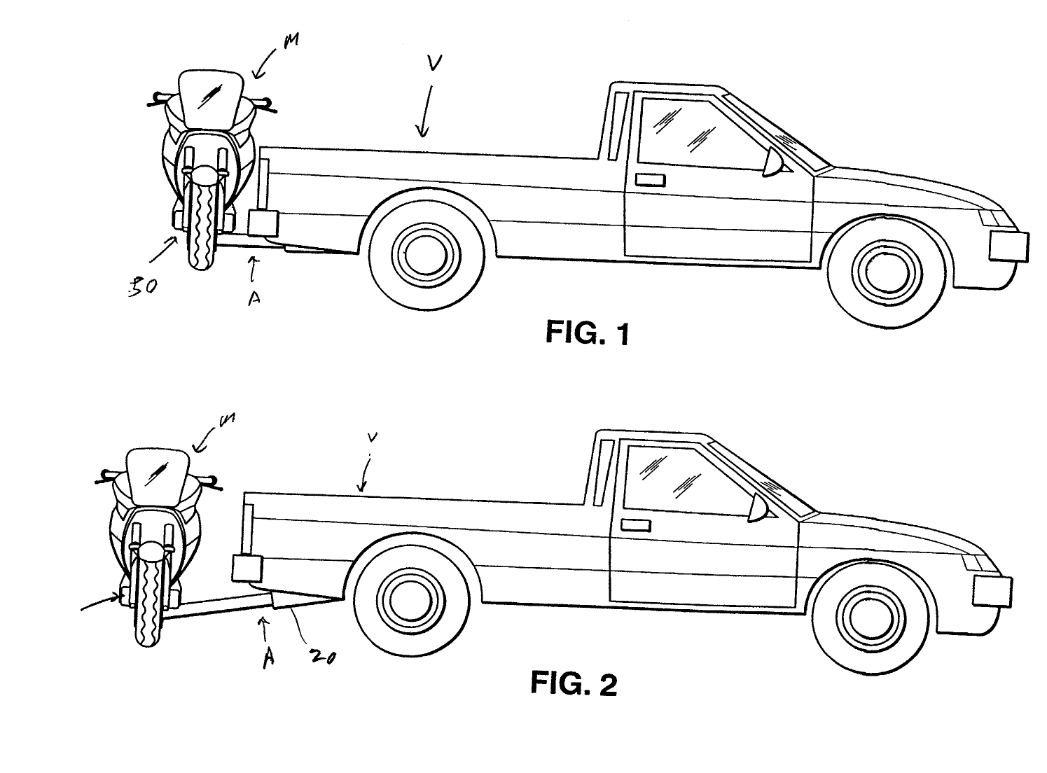

Referring now in more detail and by reference characters to the drawings which illustrate a preferred embodiment of the present invention, A designates an apparatus including a frame for mounting to the underside of an automotive vehicle V as best shown in FIGS. 1 and 2 of the drawings.

In the drawings of FIGS. 1 and 2, a sports vehicle in the nature of a motorcycle M is shown as being supported on a carriage support forming part of the apparatus, as hereinafter described. However, the use of the motorcycle is only exemplary in accordance with the present invention and any sports type vehicle of the type previously described can be loaded and transported and unloaded.

The apparatus of the invention is also shown as being mounted on the rear portion of a pickup truck. However, it should be understood, again, that this is only exemplary for purposes of the present invention and that the apparatus A could be mounted on any of a wide variety of automotive vehicles.

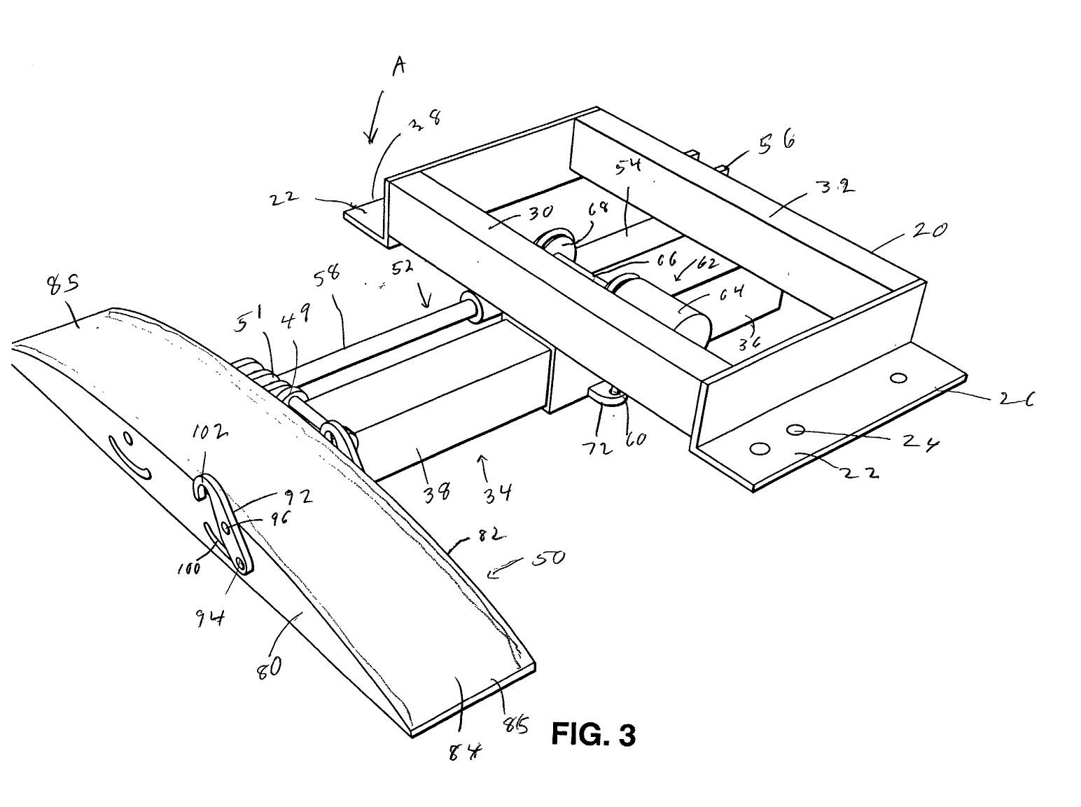

The lift and transport apparatus of the present invention generally comprises a main frame 20 having a pair of outwardly struck flanges 22 along the longitudinal sides thereof for mounting to the chassis of an automotive vehicle. Moreover, each of these flanges may be provided with bolt holes 24 or similar fastening means for securement to the underside of the chassis of the automotive vehicle. In this case, the frame is comprised of a rectangularly shaped structure open in the center portion thereof. Moreover, the frame is comprised of a pair of channel pieces 26 and 28 as shown and which are connected by steel members 30 and 32, also as shown in FIG. 3 of the drawings.

Therefore, construction of the frame has been found to be highly effective inasmuch as the channel members and the steel members are readily available. However, any frame construction could be used in accordance with the present invention. Moreover, the frame can be made from a wide variety of materials of construction, including a variety of metals, reinforced composites or the like.

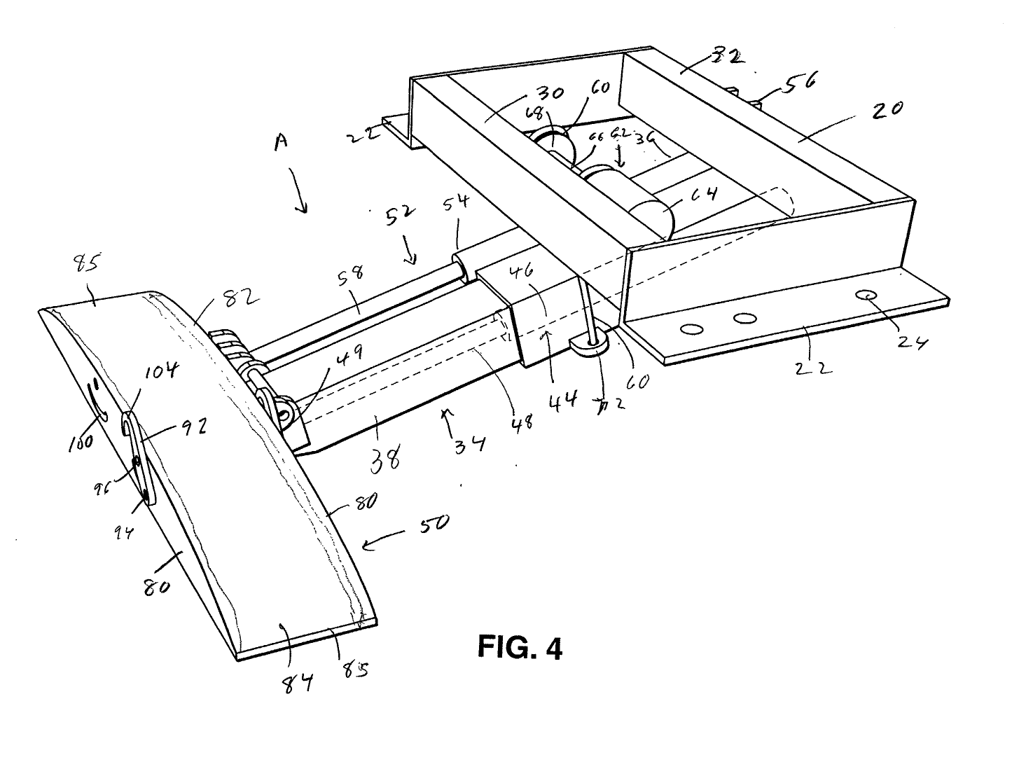

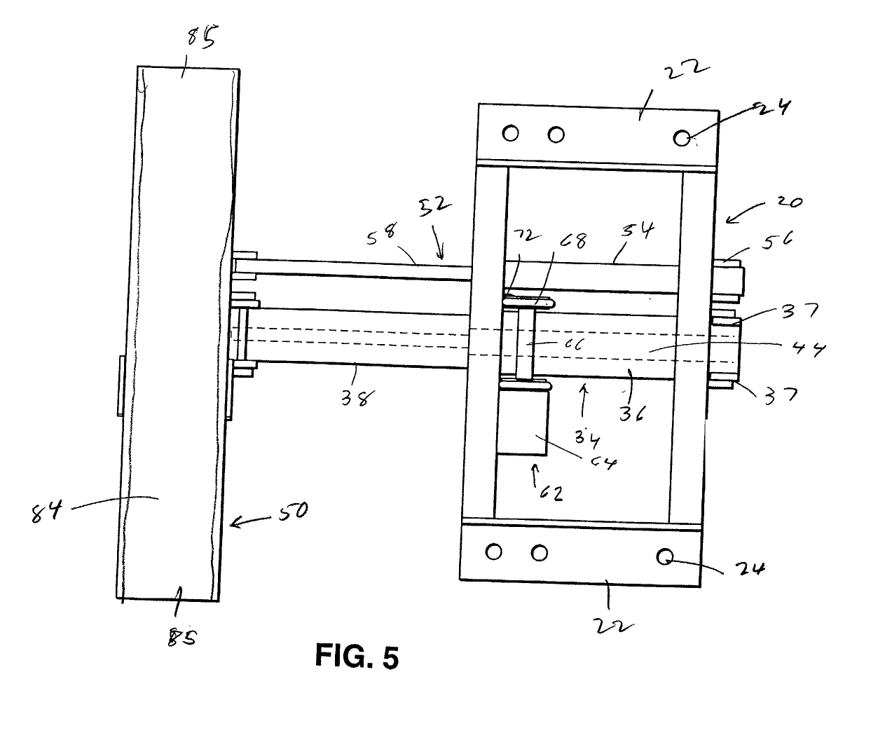

Mounted on the rear portion of the main frame 20 is a boom structure 34 comprised of a rectangularly shaped pivotally mounted boom housing 36, which is secured to the forward end of the frame 20 at a pair of pivot plates 37, all as best shown in FIGS. 3 and 4 of the drawings. Extensible into and out of the boom housing 36 is a telescopic main beam 38 which is hingedly mounted to a pivot plate 37 at the forward end of the main beam 38. In this particular case, the mounting plate 37 is provided with a pair of clevised hinge plates for pivotal securement of the forward end of the main beam 38, as shown in FIGS. 3, 4 and 5.

The beam 38 is also rectangularly shaped and hollow, much in the same manner as the boom housing 36. In this case, the telescopic main beam carries a first drive mechanism 44, such as, for example, a piston cylinder drive and in which the cylinder 46 is pivotally secured within the boom housing 36. The piston 48 thereof is pivotally secured at its forward end to a pivot 49 extending between the pivot plates 42. In this way, extension of the piston 48 will cause an extensible movement of the main beam 38.

In accordance with the construction thus far described, when it is desired to lower a carriage 50 carried at the forward end of the boom 34, the piston cylinder of the first drive mechanism 44 can be extended to cause extensible movement of the beam 38. In this way, the carriage support 50 can be extended away from the rearward end of the automotive vehicle and raised and lowered to a ground surface, as hereinafter described. Moreover, when the sports vehicle has been mounted on the carriage 50, also as hereinafter described, the beam 38 can be retracted within the boom housing 36, so that the carriage support 50 and any sports vehicle thereon can be carried adjacent to the rearward end of the automotive vehicle.

A separate drive mechanism 52 is also provided for causing extensible movement of the carriage support 50. This second extensible drive mechanism similarly comprises a piston cylinder arrangement 54 which also cooperates with, and essentially forms a part of, the boom structure 34. The cylinder of this piston cylinder arrangement 54 is mounted on a pair of pivot plates 56 at the forward end of the frame 20, also as best shown in FIGS. 3 and 4. Moreover, the piston 58 is similarly mounted on the pivot plates 51 so as to enable extensible movement for the carriage support 50.

Also mounted on the frame 20 is a second drive means 62, sometimes hereinafter referred to as a “vertical movement” drive means, and which comprises a drive motor 64 having a drive shaft 66. Mounted on this drive shaft 56 are a pair of pulleys or sprockets 68 which cause movement of either cables or chains 70. Thus, rotatable movement of the drive shaft 56 in one direction will cause a raising of the cables or chains and when driven in an opposite direction enable the cables or chains to lower. In this particular case, the sprockets carry chains 60 which are secured to mounting flanges 72 mounted on the lower end of the boom 36. Thus, the drive motor 64 will cause the raising and lowering movement of the boom 36 and, hence, the raising and lowering movement of the carriage support 50.

In this case, the drive mechanism 52 as well as the drive comprised of the cylinder 46 and piston 48, operate in conjunction with one another. They both extend together and retract together in coordinated movement so that they operate as a type of parallelogram extensible drive means. This extensible drive means provides a certain degree of rigidity to the carriage support as the latter is extended and also as the latter is raised and lowered, as hereinafter described. Although only two drive members have been shown, it is possible to operate the boom with only one drive member, although the pair of spaced apart drive members does provide this added degree of rigidity in construction. In addition, if desired, it is also possible to utilize three or more drive members operating in unison.

The vertical movement drive means 62 preferably operates in conjunction with the extensible drive means 44 so that the two cause both extension and raising and lowering movement essentially at the same time. In this way, the carriage is not extended out for any substantial distance before the boom is lowered to the ground surface. Simultaneously, there is no movement of the carriage support scraping along the ground surface after the boom has been lowered.

As indicated previously, the carriage support is always positioned properly so that any load, such as a motorcycle carried thereon, always remains in the upright position. In particular, if desired, a third drive means could be used for positioning the carriage support so that any load, such as a motorcycle, carried thereon would always remain in the upright position. Thus, for example, another piston cylinder drive, operating as a tilting movement drive, could be mounted on the exterior surface of the beam 38 and could be pivotally attached to the forwardly facing surface of the carriage support 50. This particular drive would thereby cause the tilting movement of the carriage support as the latter is extended and retracted, and as the latter is lowered and raised.

In accordance with a preferred embodiment of the present invention, and inasmuch as a pair of piston cylinder extensible drives are employed, namely, the drive 44 and the drive 52, these two drives, in effect, provide that tilting drive mechanism. The main piston-cylinder drive 44 located within the beam 38, can cause the extensible and retracting movement of the carriage support 50. The drive 52 could effectively operate to cause that tilting movement. Moreover, since each of these drive mechanisms form a type of parallelogram with the forward portion of the frame 20 and the boom 50, they effectively operate together to hold the carriage support 50 in a position where the load mounted thereon is always maintained in an upright position.

By reference to FIG. 7, it can be seen that the main drive 44, located within the boom 36, is connected to a lower end of the carriage support 50, namely, at a pivot point 76. The piston-cylinder drive 52 is pivotally secured to the upper end of the carriage support 50 at a pivot point 78, as shown in FIG. 7. Obviously, these two could be reversed in their pivoted position on the carriage support 50. Nevertheless, the two operate in conjunction with one another and maintain this true parallel relationship so that the carriage support 50 remains in a horizontal position.

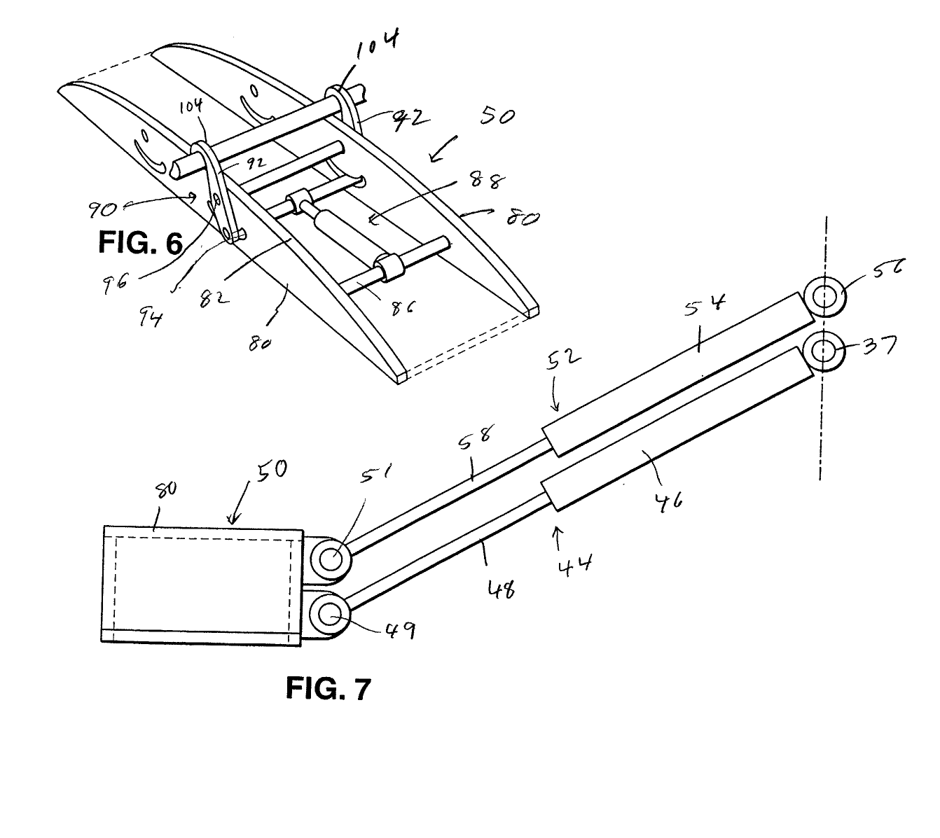

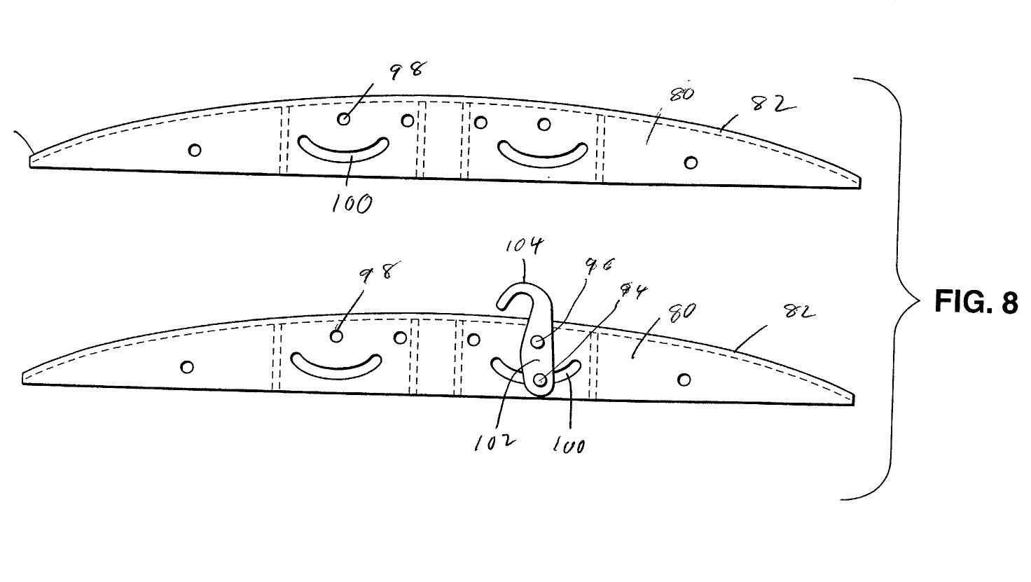

The carriage support 50 is more fully illustrated in FIGS. 6 and 8 of the drawings. In particular, the carriage support 50 is provided with a pair of aluminum outer plates, or so-called “rails”, 80 which have upper edges 82. Moreover, these aluminum plates carry an interior frame structure (not shown) to provide structural integrity, as well as an outwardly facing ramp 84. The ramp may be in the form of a flat aluminum sheet rolled on the rails 80 and welded thereto thereby creating a continuous ramp. However, if desired, the plates 80 could have upwardly projected grid edges 82 as shown in FIG. 3. The ramp 84 has end portions 85 which engage a ground surface. Thus, a motorcycle or similar wheeled sports vehicle can be literally rolled onto the ramp 84. The upper edges 82 of the outer plates 80 extend slightly above the ramp 84, so as to provide edges to preclude rolling of the motorcycle off of the carriage support 50.

Mounted on the outer rails 80 is a pivot rod 86 which carries a locking mechanism drive member 88. This locking mechanism drive member 88 operates a locking mechanism 90 comprised of a plurality of hooks 92, also as hereinafter described. It can be observed that the locking mechanism drive 88 is also a piston cylinder drive arrangement and is pivotally secured to another pivot pin 94 at lower ends of each of the hooks 92. Moreover, each of the hooks are pivotally journaled onto the rails 80 by means of a pivot pin 96, also as shown in FIG. 6 of the drawings. This pivot pin 96 constitutes a fixed pivot point for each of the hooks 92. However, the pivot pin 96 can be repositioned, as may be required, in order to accommodate a particular sports vehicle. In like manner, each of the pivot rods 86 can also be repositioned.

The hooks 92 are sized and located to engage a portion of the frame of the motorcycle or other sports vehicle or otherwise a custom steel strap specifically designed for each type of vehicle, and which is mounted to the sports vehicle. These hooks 92 could adopt the form of straight plates connecting a steel rod and which would be adapted to engage hooks actually mounted onto the sports vehicle.

By reference FIG. 8 of the drawings, it can be seen that there are a plurality of apertures 98 for receiving the pivot 96. Thus, and in this way, the hooks can be repositioned to face in an opposite direction. Moreover, the pivot rods 94 can ride in arcuate grooves 100 located in the rails. For this purpose, the various pins can be repositioned to essentially reposition the hooks in a variety of positions in order to accommodate a particular sports vehicle. Thus, for example, if one sports vehicle has a frame member located in a different position with respect to another sports vehicle, the hooks themselves can be repositioned to accommodate that particular sports vehicle.

Each of the hooks are provided with elongate arms 102 and hook ends 104. In this way, the hook ends can be located in a desired arrangement to engage and physically grasp the portion of the motorcycle or other sports vehicle carried on the carriage support 50.

In substance, it can be observed that there is a drive mechanism for raising and lowering the boom, and a separate drive mechanism for extending the boom. In addition, if desired, this extensible drive means for extending and retracting the boom also causes a positioning of the carriage support so that a load carried thereon is always in an upright position. However, and as indicated previously, it is possible to use a separate tilt drive mechanism to insure that the carriage support always remains in an upright position. Further, there is provided a drive mechanism which operates the mounting means and in this case, the particular hooks as shown. It should be also recognized that a control circuit controlling each of the individual drive means could be provided, if desired, and to maintain a synchronous operation of each of the various activities heretofore described.

Thus there has been illustrated and described a unique and novel apparatus and method for transporting with an automotive vehicle a straddled sports vehicle, and which thereby fulfills all of the objects and advantages which have been sought. It should be understood that many changes, modifications, variations, and other uses and applications will become apparent to those skilled in the art after considering this specification and the accompanying drawings. Therefore, any and all such changes, modifications, variations and other uses and applications which do not depart from the spirit and scope of the invention are deemed to be covered by the invention.

Having thus described the invention, what I desire to claim and secure by Letters Patent is:

1. Apparatus for loading and transporting at the rear of an automotive vehicle a motor driven straddled sports vehicle of the type supported on two running members, said apparatus comprising:
a) a frame capable of being mounted on the underside of an automotive vehicle;
b) a main beam extending outwardly from said frame;
c) a carriage support mounted on an outer end of said main beam and adapted to engage an undercarriage of the motor driven sports vehicle;
d) means associated with said carriage support to hold the motor driven vehicle in a generally upright position; and
e) means for lowering the main beam and raising same, such that when the motor driven sports vehicle is secured to the carriage support, it will be retained thereon for transport in a generally upright position without further tying or securement.

2. The apparatus for loading and transporting a motor driven sports vehicle of claim 1 further characterized in that means is provided for tilting the position of the carriage support relative to the main beam when the latter is lowered to a ground surface so that the carriage support has a surface which loads and unloads the motor driven vehicle in a generally upright position and raised from the ground surface to a horizontally disposed position so that the motor driven vehicle will be retained and transported to a destination in an upright position.

3. The apparatus for loading and transporting a motor driven straddled sports vehicle of claim 1 further characterized in that an extensible drive means is associated with said main beam for carrying a telescoping section of said main beam to extend outwardly away from said automotive vehicle to thereby engage a motor driven vehicle and thereafter extend inwardly to retract and cause movement of the motor driven vehicle to a position of adjacent relationship to the automotive vehicle.

4. The apparatus for loading and transporting a motor driven straddled sports vehicle of claim 3 further characterized in that a pivot enabling drive means causes said carriage support to maintain a position where a mounting area thereon is generally horizontally disposed when the main beam reaches a ground position so that the motor driven vehicle will be retained and transported in an upright position.

5. The apparatus for loading and transporting a motor driven straddled sports vehicle of claim 4 further characterized in that a vertical movement drive means causes said main beam to be shifted in a vertical path so that said carriage support is moved from a raised position spaced above a ground surface to the ground surface and back to a raised position above the ground surface when the motor driven vehicle is mounted thereon.

6. The apparatus for loading and transporting a motor driven straddled sports vehicle of claim 4 further characterized in that each of said drive means are electrically powered drive means.

7. The apparatus for loading and transporting a motor driven straddled sports vehicle of claim 1 further characterized in that said apparatus is provided with securement means for mounting to the undercarriage of an automotive vehicle and the carriage support is provided with a releasable mounting means to releasably mount a motor driven vehicle which is a two wheeled motorcycle.

8. The apparatus for loading and transporting a motor driven straddled sports vehicle of claim 1 further characterized in that said apparatus is provided with securement means for mounting to the undercarriage of an automotive vehicle and the carriage support is provided with a releasable mounting means to mount a motor driven vehicle which is a jet ski.

9. The apparatus for loading and transporting a motor driven straddled sports vehicle of claim 7 further characterized in that said carriage support has a curved ramp allowing easy rolling of a motorcycle onto said ramp and to a position over said mounting means.

10. The apparatus for loading and transporting a motor driven straddled sports vehicle of claim 9 further characterized in that said mounting means comprises hook means on said carriage support and said hook means are positionable on said carriage support to obtain an optimum position of mounting said motor driven vehicle with said hooks.

11. Apparatus for raising and lowering and transporting an auxiliary vehicle at the rear portion of an automotive vehicle, said apparatus comprising:
a) a frame having means for mounting on a rear portion of said automotive vehicle;
b) a carriage support operatively coupled to and movable with said frame and also independently of said frame;
c) mounting means on said carriage support for releasably mounting the auxiliary vehicle thereon so that the auxiliary vehicle is capable of being completely lifted from the ground surface to a raised transport position; and
d) means for raising and lowering said carriage support so that the auxiliary vehicle is completely lifted from a ground surface and where the auxiliary vehicle is automatically retained in a generally upright position during said raising and lowering movement and during transport.

12. Apparatus for raising and lowering and transporting an auxiliary vehicle of claim 11 further characterized in that a means is provided for tilting the position of the carriage support relative to the frame when the latter is lowered to a ground surface so that the carriage support has a surface which allows for loading and unloading the auxiliary vehicle in a generally upright position and raised from the ground surface to a horizontally disposed position above the ground surface so that the auxiliary vehicle will be retained in an upright position during raising and lowering movement and transported in an upright position.

13. Apparatus for raising and lowering and transporting an auxiliary vehicle of claim 12 further characterized in that said method comprises causing said carriage support to maintain a position where a mounting area thereon is generally horizontally disposed when the carriage support reaches a ground position so that the auxiliary vehicle will be retained and transported in an upright position.

14. The apparatus for raising and lowering and transporting an auxiliary vehicle of claim 13 further characterized in that a drive means causes said carriage support to be shifted in a vertical path so that said carriage support is moved from a raised position spaced above a ground surface and back to a position at the ground surface when the auxiliary vehicle is mounted thereon.

15. The apparatus for raising and lowering and transporting an auxiliary vehicle of claim 14 further characterized in that said apparatus is provided with securement means for securement to the underside of an automotive vehicle and which is two wheeled motorcycle.

16. A method for loading and transporting a motor driven straddled sports vehicle onto an apparatus which carries same with an automotive vehicle and allows for transport with the automotive vehicle, said method comprising:
a) lowering a carriage support forming part of said apparatus to a ground surface to receive the motor driven sports vehicle;
b) moving the motor driven sports vehicle onto the carriage support of the assembly;
c) releasably mounting the motor driven sports vehicle onto the carriage support;
d) raising the carriage support to a raised position above a ground surface and simultaneously holding said support in such position that the motor driven vehicle is always held in a generally upright position;
e) transporting the motor driven sports vehicle to a destination;
f) lowering the carriage support to a ground surface at the destination and simultaneously maintaining the carriage support in a position so that the motor driven sports vehicle is in the generally upright position; and
g) removing the motor driven sports vehicle from the carriage support.

17. The method for loading and transporting a motor driven straddled sports vehicle of claim 16 further characterized in that said method comprises tilting the position of the carriage support as the latter is raised and lowered so that a mounting means on said carriage support always carries the motorized vehicle in a generally upright position during such raising and lowering movement.

18. The method for loading and transporting a motor driven straddled sports vehicle of claim 16 further characterized in that said method comprises moving said carriage support outwardly from the automotive vehicle to load the vehicle and unload the automotive vehicle and also retracting the carriage support to be in an adjacent position to the automotive vehicle after loading and unloading.

19. The method for loading and transporting a motor driven straddled sports vehicle of claim 17 further characterized in that said mounting means comprises hook means, and said method comprises shifting said hook means to a desired position to mount the motor driven vehicle to said carriage support depending on the construction of the motor driven vehicle.
